(19) United States
(12) Patent Application Publication
(10) Pub. No.: US 2017/0215151 A1
(43) Pub. Date: Jul. 27, 2017

(54) COMMUNICATION DEVICE

(71) Applicant: JIENG TAI INTERNATIONAL ELECTRIC CORP., New Taipei City (TW)

(72) Inventors: Yu-Pang CHOU, New Taipei City (TW); Pei-Zong RAO, New Taipei City (TW); Chih-Kung CHANG, New Taipei City (TW)

(21) Appl. No.: 15/168,101

(22) Filed: May 30, 2016

(30) Foreign Application Priority Data
Jan. 27, 2016 (TW) 105102542

(51) Int. Cl. H04W 52/18; H04W 52/08; H04W 52/10

(52) U.S. Cl. CPC H04W 52/18; H04W 52/10; H04W 52/08; H04W 88/02

(57) ABSTRACT

A communication device includes an antenna unit, a sensing unit and a radio frequency unit. The antenna unit is configured to send a radio frequency signal. The sensing unit is coupled to a ground terminal through a capacitor and configured to sense a first capacitance through the antenna unit. The radio frequency unit is configured to generate the radio frequency signal, and to adjust energy of the radio frequency signal to a first energy according to the first capacitance. When the energy if the radio frequency signal is the first energy, the sensing unit is configured to sense a second capacitance through the antenna unit. The radio frequency unit is configured to adjust the energy of the radio frequency signal from the first energy to a second energy according to the second capacitance.

### RELATED APPLICATIONS

This application claims priority to Taiwan Application Serial Number 105102542, filed Jan. 27, 2016, which is herein incorporated, by reference.

### BACKGROUND

Technical Field

The present invention relates to a communication device. More particularly, the present invention relates to a communication for improving antenna performance.

Description of Related Art

A communication device can send or receive radio waves through an antenna so as to transmit or exchange radio signals. However, operational performance of radio signals is easily affected by environmental factors (e.g., a human body or another electronic device). Using the example of a portable electronic device (e.g., a cell phone), when a user uses the portable electronic device, performance of an antenna in the portable electronic device is decreased because the human's body is nearby. Therefore, in different application scenarios, effects on performance of antennas are different, which makes performance of the antennas difficult to be improved effectively.

### SUMMARY

In order to improve antenna performance in different application scenarios, the present disclosure provides a communication device, which includes an antenna unit, a sensing unit and a radio frequency unit. The antenna unit is configured to send a radio frequency signal. The sensing unit is coupled to a ground terminal through a capacitor, and configured to sense first capacitance through the antenna unit. The radio frequency unit is configured to generate radio frequency signal and to adjust energy of the radio frequency signal to the first energy according to the first capacitance. When the energy of the radio frequency signal is the first energy, the sensing unit is configured to sense a second capacitance through the antenna unit. The radio frequency unit is configured to adjust the energy of the radio frequency signal from the first energy to the second energy according to the second capacitance.

In an embodiment of the present disclosure, the communication device further includes a first control unit, which is configured to generate a first control signal according to the first capacitance and to send the first control signal to the radio frequency unit. The radio frequency unit receives the first control signal to adjust the energy of the radio frequency signal to the first energy.

In an embodiment of the present disclosure, when the first capacitance is larger than a first threshold value, the first control unit generates the first control signal and sends the first control signal to the radio frequency unit.

In an embodiment of the present disclosure, the communication device further includes a second control unit, which is configured to generate a second control signal and to send the second control signal to the radio frequency unit according to the second capacitance. The radio frequency unit receives the second control signal to adjust the energy of the radio frequency signal from the first energy to the, second energy.

In an embodiment of the present disclosure, when the second capacitance is larger than a second threshold value, the second control unit generates the second control signal and sends the second control signal to the radio frequency unit.

In an embodiment of the present disclosure, the first control unit generates the first control signal through an open loop method.

In an embodiment of the present disclosure, the second control unit generates the second control signal through a closed loop method.

In an embodiment of the present disclosure, the sensing unit, the radio frequency unit, the first control unit and the second control unit are integrated'in a package.

In an embodiment of the present disclosure, the sensing unit s coupled to the antenna unit.

In an embodiment of the present disclosure, the sensing unit configured to detect whether a human body approaches the communication device.

In conclusion, the present disclosure can use the antenna unit of the communication device itself to sense a capacitance in a range, and effectively optimize the radio frequency signal by a two-step method of adjusting the radio device. The present disclosure doesn't need an additional receiver or sensor, and therefore can save fabrication costs and increase area of the antenna unit.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the embodiment with reference made to the accompanying drawings as follows:

FIG. 1 is a schematic diagram of a communication device according td an embodiment of the present disclosure;

FIG. 2 is a schematic diagram of a o ion device according to an embodiment of the present disclosure;

FIG. 3 is a schematic diagram of a communication device according to an embodiment of the present disclosure; and

FIG. 4 is a Smith chart of a communication device according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the disclosure. As used herein, the singular forms “a”, “an” and the are intended to include the plural forms as well, unless the context clearly indicates otherwise. It will be further understood that the terms “comprises” and/or “comprising”, or includes and/or “including” or “has” and/or “having” when used in this specification, specify the presence of stated features, regions, integers, steps, operations, elements, and/or components, but do not preclude the presence or addition of one or more other features, regions, integers, steps, operations, elements components, and/or groups thereof.

In this document, the term “coupled” may also be termed as “electrically coupled,” and the term “connected” may be termed as “electrically connected.” “Coupled” and “connected” may also be used to indicate that two or more elements cooperate or interact with each other.

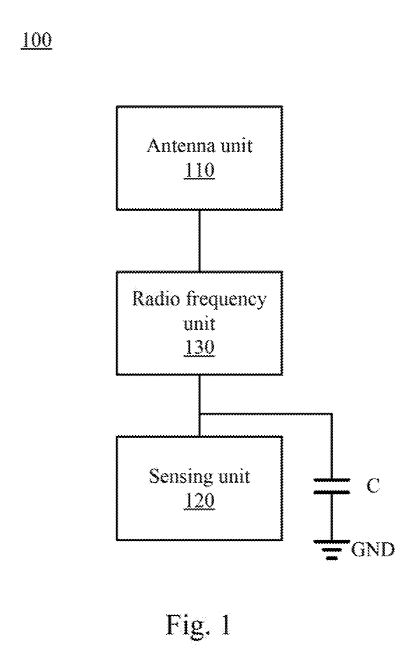

Reference is made to FIG. 1. FIG. 1 is schematic diagram of a communication device 100 according to an embodiment of the present disclosure. The communication device 100 may be any electronic product with a communication function such as a cell phone, a tablet PC, a wireless access point device, etc. As shown in FIG. 1 in the present embodiment, the communication device 100 includes an antenna unit 110 a sensing unit 120 and a radio frequency unit 130. The sensing unit 120 is coupled to a ground terminal GND through a capacitor. As a result, when the sensing unit 120 senses a capacitance through the antenna unit 110, direct current of the sensing unit 120 is not grounded. Hence, the sensed capacitance will not be affected.

Operationally, the antenna unit 110 is configured to send a radio frequency (RF) signal. The sensing unit 120 is configured to sense a first capacitance through the antenna unit 110. The radio frequency unit 130 is configured to generate the radio frequency signal, and adjust energy of the radio frequency signal to a first energy according to the first capacitance. When the energy of the radio frequency signal is the first energy, the sensing unit 120 is configured to sense a second capacitance through the antenna unit 110. The radio frequency unit 130 is configured to adjust the energy of the radio frequency signal from the first energy to a second energy according to the second capacitance.

Specifically, the sensing unit 20 an be configured to sense whether a human body approaches the communication device 100, so as to decide a specific absorption rate (SAR) for the communication device 100. When a human body approaches the communication device 100, a capacitance of a coupling capacitor sensed by the antenna unit 110 is changed. Therefore, the sensing unit 120 can sense the capacitance of the coupling capacitor, that is, the first capacitance, through the antenna unit 110. The radio frequency unit 130 then adjusts the energy of the radio frequency signal to the first energy according to the first capacitance. When the energy of the radio frequency signal is adjusted to the first energy, the sensing unit 120 senses the second capacitance through the antenna unit 110, and the radio frequency unit 130 is configured to adjust the energy of the radio frequency signal from the first energy to the second energy according to the second capacitance.

In the present embodiment, the sensing unit 120 may be coupled to the antenna unit 110. In other words, the antenna unit 110 may be used as a sensing element of the sensing unit 120. Specifically, the present disclosure uses the antenna unit 110 of the communication device 100 itself to sense the capacitance within a range so that a first control unit 240 and a second control unit 250 adjust the energy of the radio frequency signal according to capacitance. Therefore, there is no need to additionally install the receiver or the sensor in the communication device 100, thus fabrication cost may be decreased and the area of the antenna unit 110 may be increased.

As a result, the communication device 100 of the present disclosure can use the antenna unit 110 to sense the capacitance within a range, and effectively optimize the radio frequency signal through a method with a two-stage adjustment of the energy of the radio frequency signal when a human body approaches the communication device 100.

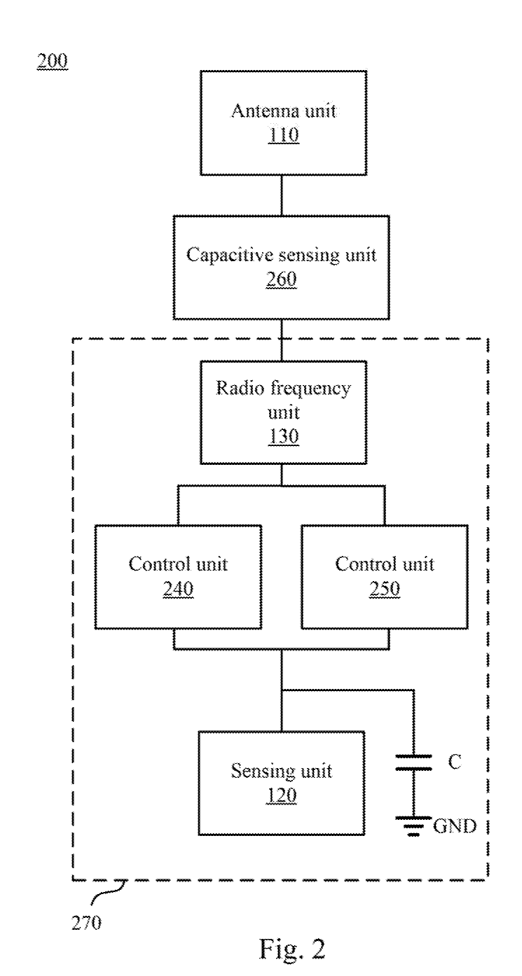

In order to further describe details about the radio frequency unit 130 adjusting the energy of the radio frequency signal, reference is made to FIG. 2, FIG. 2 is a schematic diagram of a communication device 200 according to an embodiment of the present disclosure. The communication device 200 has substantially the same configuration as the communication device 100, except a first control unit 240 and a second control unit 250. The first control unit 240 is configured to generate a first control signal according to the first capacitance, and send the first control signal to the radio frequency unit 130. The radio frequency unit 130 receives the first control signal to adjust the energy of the radio frequency signal to the first energy. The second control unit 250 is configured to generate a second control signal according to the second capacitance, and send the second control signal to the radio frequency unit 130. The radio frequency unit 130 receives the second control signal to adjust the energy of the radio frequency signal from the first energy to the second energy.

In one embodiment, the first control unit 240 may compare the first capacitance sensed by the sensing unit 120 with a first threshold value to determine whether a human body approaches the communication device 100. When the first capacitance is larger than the first threshold value, it indicates that the human body approaches the communication device 100, and at this moment, the first control unit 240 generates the first control signal and sends the to the radio frequency unit 130 so as to control the radio frequency unit 130 to adjust the energy of the radio frequency signal to the first energy. In one embodiment, the radio frequency unit 130 reduces the energy of the radio frequency signal according to the first control signal. When the radio frequency signal is the first energy, the second control unit 250 may compare the second capacitance sensed by the sensing unit 120 with a second threshold value. When the second capacitance is larger than the second threshold value, it indicates that the human body still has a certain influence on the radio frequency signal, and the second control unit 250 may generate the second control signal and send the second control signal to the radio frequency unit 130 to control the radio frequency unit 130 to adjust the energy of the radio frequency signal from the first energy to the second energy.

In one embodiment, the first control unit 240 generates the first control signal through an open loop method. Specifically, the first control unit 240 generates the first control signal according to an influence of a phantom hand on the radio frequency signal. The radio frequency unit 130 receives the first control signal to adjust the energy of the radio frequency signal to the first energy, and then compensates an equivalent influence of the phantom hand on the radio frequency signal.

In one embodiment, the second control unit 250 generates the second, control signal through a closed loop method. Specifically, when the radio frequency unit 130 adjusts the radio frequency signal to the first energy, because gestures of holding the communication device 200 by users are not the same, different gestures have different influences on the communication device 200. When the radio frequency signal is the first energy, the second control unit 250 executes a loop computation to generate the second control signal according to an actual influence of the human body on the radio frequency signal. The radio frequency unit 130 receives the second control signal to adjust the energy of the radio frequency signal from the first energy to the second energy, and then compensates an actual influence of a human hand on the communication device 200.

As a result, the present disclosure uses the open loop method of the first control unit 240 and the closed loop method of the second control unit 250 to effectively reduce burdens of the closed loop computation and to optimize the energy of the radio frequency signal. Therefore, the present disclosure can be applicable to application scenarios for using the communication device with different gestures, and improve efficiency of radio frequency signal adjustments.

In one embodiment, the communication device 100 further includes a capacitive sense unit 260. The capacitive sense unit is coupled between the antenna unit 110 and the radio frequency unit 130. The sensing unit 120 can sense a capacitance of the capacitive sense through the antenna unit 110. In practice, the capacitive sense unit 260 may be a capacitor. However, the present disclosure is not limited to the embodiment.

In one embodiment, the sensing unit 120 the radio frequency unit 130, the first control unit 240 and the second control unit 250 are integrated in a package 270. Specifically besides the antenna unit 310, other units and components (e.g., the sensing unit 120, the radio frequency unit 130, the first control unit 240 and the second control unit 250, etc.) of the communication device 200 can be integrated into one package (e.g., the package 270) by using a system in package (SIP) technology. Therefore, the fabrication cost of the communication device 200 may be reduced, and arrangement flexibility of other components in the communication device 300 may be increased.

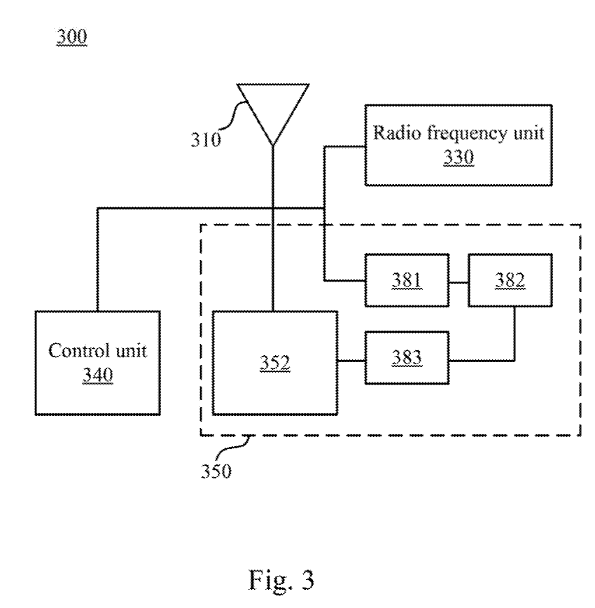

In order to describe details about the first control unit and the second control unit, reference is made to FIG. 3. FIG. 3 is a schematic diagram of a communication device 300 according to an embodiment of the present disclosure. The communication device 300 has substantially the same configuration as the communication device 100, except a first control unit 340 and a second control unit 350. Specifically, the first control unit 340 includes an integrated circuit chip, and the second control unit 350 includes an integrated circuit chip 352, a coupler 381, a power detector 382 and a high voltage digital to analog converter (HV DAC) 383.

Operation of the communication device 300 is similar to the above description. When the human body approaches the communication device 300, a capacitance of a coupling capacitor sensed by the antenna unit 110 will be changed. The first control unit 340 can generate the first control signal according to the first capacitance to control the radio frequency unit 330 to adjust the energy of the radio frequency signal to the first energy. The second control unit 350 uses the coupler 381, the power detector 382, the high voltage digital to analog converter 383 and the integrated circuit chip 352 to detect the second capacitance in real time and to send the second control signal to control the radio frequency unit 330 to adjust the energy of the radio frequency signal. In one embodiment, the second control unit 350 computes an optimized energy of the radio frequency signal through loop method by software, and generates the corresponding second control signal to control the radio frequency unit 330 to adjust the energy of the radio frequency signal from the first energy to the second energy.

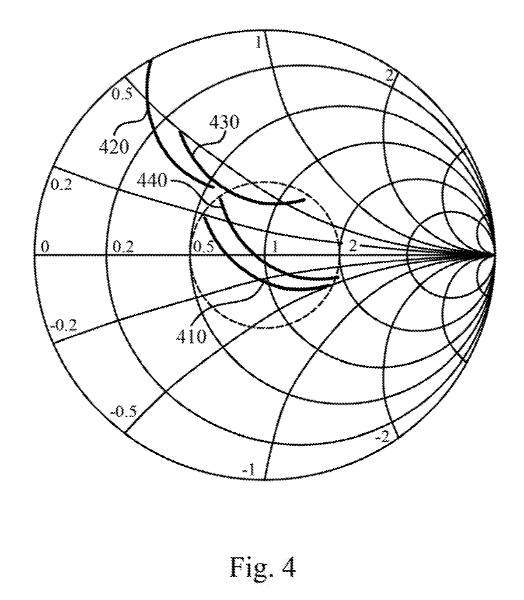

Reference is made to FIG. 4. FIG. 4 is a Smith chart of communication devices 100, 200 and 300 according to an embodiment of the present disclosure. Curve 410 indicates communication devices 100, 200 and 300 in ideal states. When a user holds the communication devices 100, 200 and 300 with hands, radio frequency signals of the communication devices 100, 200 and 300 have frequency shifts (shown as curve 420). When the radio frequency unit 130 adjusts the energy of the radio frequency signal to the first energy, characteristics of the communication devices 100, 200 and 300 are shown as curve 430. Although the curve 430 is better than the curve 420, the curve 430 is still not dose to the ideal curve 410. When the radio frequency unit 130 adjusts the energy of the radio frequency signal to the second energy, characteristics of the communication devices 100, 200 and 300 are shown as curve 440. Compared to the curve 430, the curve 440 is closer to the ideal curve 410.

Through the above embodiments, the present disclosure can use the antenna unit of the communication device itself to sense a capacitance in a range, and effectively optimize the radio frequency signal by a two-step method of adjusting the radio frequency signal energy when a human body approaches the communication device. The present disclosure doesn't need an additional receiver or sensor, and therefore can save fabrication cost and increase area of the antenna unit.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A communication device comprising:
an antenna unit, configured to send a radio frequency signal;
a sensing unit, coupled to a ground terminal through a capacitor and configured to sense a first capacitance through the antenna unit;
a radio frequency unit, configured to generate the radio frequency signal, and to adjust an energy of the radio frequency signal to a first energy according to the first capacitance; wherein when the energy if the radio frequency signal is the first energy, the sensing unit is configured to sense a second capacitance through the antenna unit, and the radio frequency unit is configured to adjust the energy of the radio frequency signal from the first energy to a second energy according to the second capacitance.

2. The communication device of claim 1, further comprising:
a first control unit, configured to generate a first control signal according to the first capacitance and to send the first control signal to the radio frequency unit, wherein the radio frequency unit receives the first control signal to adjust the energy of the radio frequency signal to the first energy.

3. The communication device of claim 2, wherein when the first capacitance is larger than a first threshold value, the first control unit generates the first control signal and sends the first control signal to the radio frequency unit.

4. The communication device of claim 2, further comprising:
a second control unit, configured to generate a second control signal and to send the second control signal to the radio frequency unit according to the second capacitance, wherein the radio frequency unit receives the second control signal to adjust the energy of the radio frequency signal from the first energy adjust to the second energy.

5. The communication device of claim 4, wherein when the second capacitance is larger than a second threshold value, the second control unit generates the second control signal and sends the second control signal to the radio frequency unit.

6. The communication device of claim 2, wherein the first control unit generates the first control signal through an open loop method.

7. The communication device of claim wherein the second contra generates the second control signal through a closed loop method,

8. The communication device of claim 4, wherein the sensing unit, the radio frequency unit, the first control unit and the second control unit are integrated in a package.

9. The communication device of claim 1, wherein the sensing unit is coupled to the antenna unit.

10. The communication device of claim 1, further comprising:
a capacitive sensing unit, coupled between the antenna unit and the radio frequency unit.
